(19) United States
(12) Patent Application Publication
(10) Pub. No.: US 2005/0155801 A1
(43) Pub. Date: Jul. 21, 2005

(54) Waterproof device for a controller of an electric mobility scooter

(76) Inventor: Chun-Moun Lin, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/957,114

(22) Filed: Oct. 4, 2004

(30) Foreign Application Priority Data
Jan. 19, 2004 (TW) 093200945

(51) Int. Cl. B62D 1/00

(52) U.S. Cl. 180/65.1

(57) ABSTRACT

A waterproof device for a controller of an electric mobility scooter is incorporated with a rear section of the electric mobility scooter, a rear cover, a motor and a controller. The motor and the controller are secured on the rear section. The rear cover covers the motor and the controller. The rear cover has an inner wall to cover front and rear ends of the controller. The rear cover comprises a pair of blocking walls extending from the inner wall to enclose two sides of the controller. Each of the blocking walls has an outer edge corresponding to the contour of the motor. The controller is protected within the blocking walls.

### BACKGROUND OF THE INVENTION

1. Field of the Invention

This invention relates to a waterproof device for a controller of an electric mobility scooter, and more particularly to a pair of blocking walls extending from an inner wall of a rear cover to enclose a controller.

2. Description of the Prior Art

An electric mobility scooter is convenient to disablers or elders. A controller to operate the scooter is the heart of the scooter. The controller is provided with wires and switches. If something happens to the controller, the entire scooter will be motionless. In many events, the water came into the controller made short circuit, and the scooter could malfunction.

As shown in FIG. 4, a conventional electric mobility scooter is provided with a rear cover 7 to cover a controller 8 secured at a rear section 6 of the scooter. The rear section 6 of the scooter is connected with a pair of rear wheels 9. The inner wall of the rear cover 7 is designed to cover the front and rear edges of the controller 8 and wiring terminals 81 of the controller 8. When driving through a watering area, water will spur up through the rear wheels 9. Some of the water will remain on the inner wall of the rear cover 7 and then drip onto the top of the controller 8 and the wiring terminals 81 to cause short circuit. Further, the controller 8 is secured at a lower position of the rear section. Thus dust may easily be collected.

Another design was derived to improve the aforesaid shortcoming, also as shown in FIG. 4. A cover 82 is applied to cover the controller 8 as a waterproof measure. The cover 82 must be made in a separated molding procedure, which is expensive both in manufacture and in assembly.

### SUMMARY OF THE INVENTION

It is the primary advantage of the present invention to provide a waterproof device for a controller of an electric mobility scooter, which has a pair of blocking walls extending from an inner wall of a rear cover to enclose a controller to prevent water or dust from getting onto the controller.

It is another advantage of the present invention to provide a waterproof device for a controller of an electric mobility scooter, which has a longer lifespan.

It is a further advantage of the present invention to provide a waterproof device for a controller of an electric mobility scooter, which reduces the production cost.

### BRIEF DESCRIPTION OF THE DRAWINGS

FIG. 1 is an exploded view of the present invention;

FIG. 2 is a side view of the present invention;

FIG. 3 is an enlarged view of the present invention; and

FIG. 4 is an exploded view of a prior art.

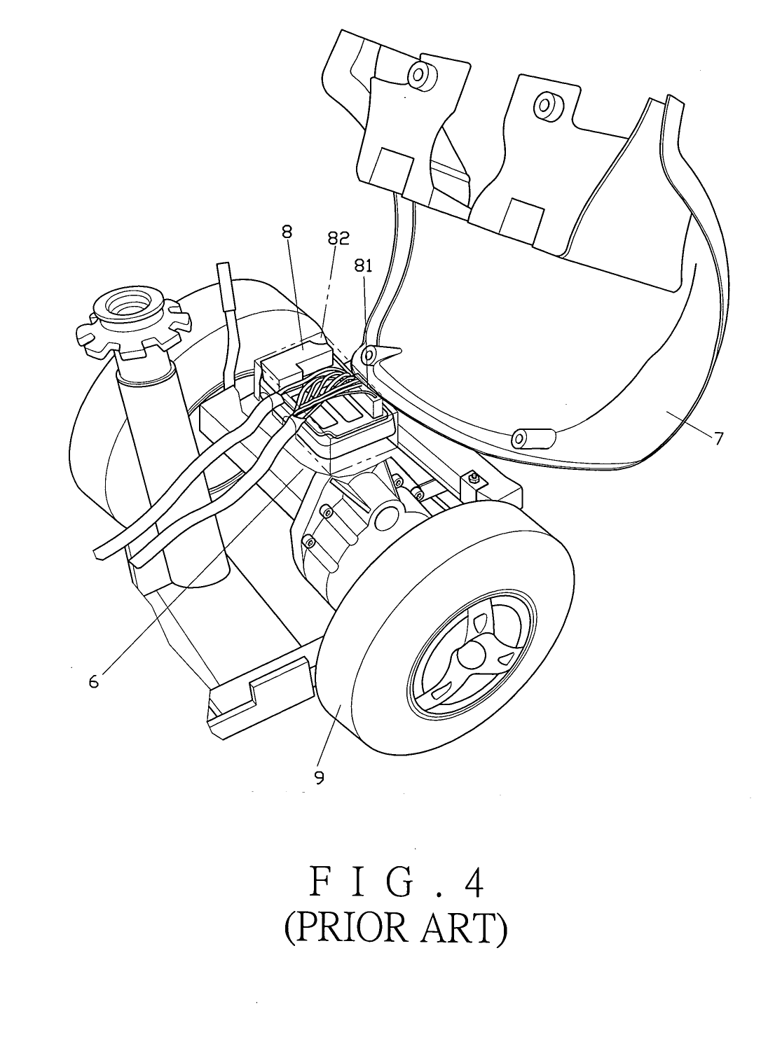

### DETAILED DESCRIPTION OF THE PREFERRED EMBODIMENT

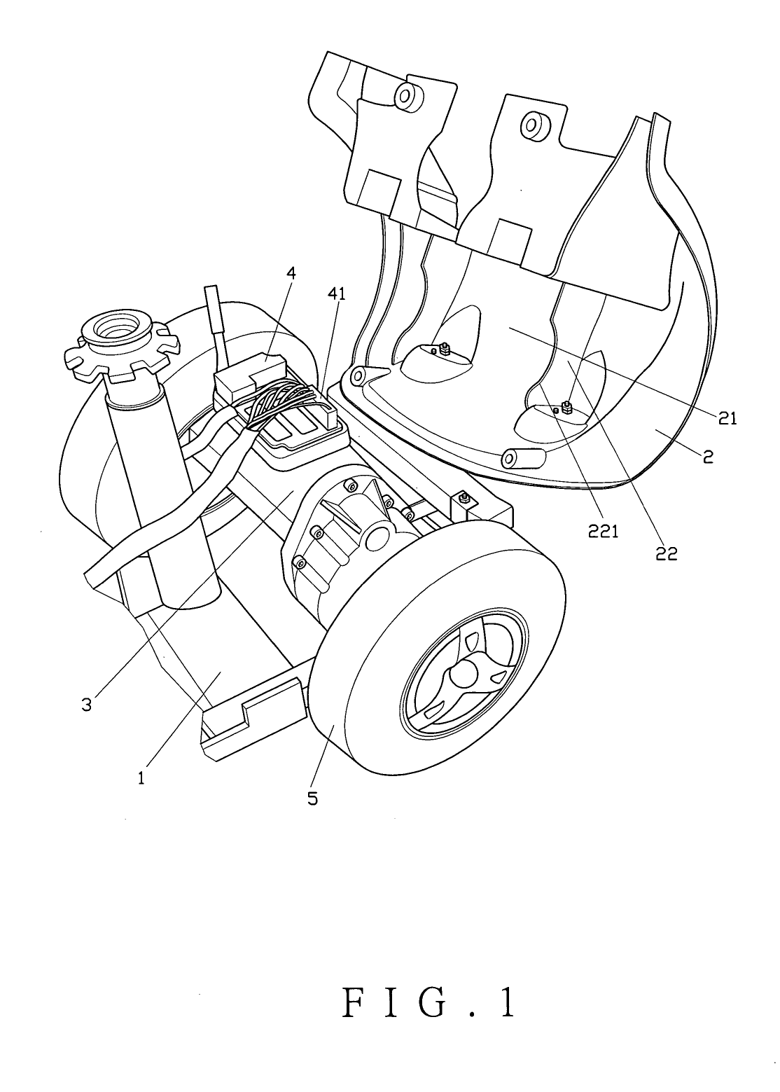

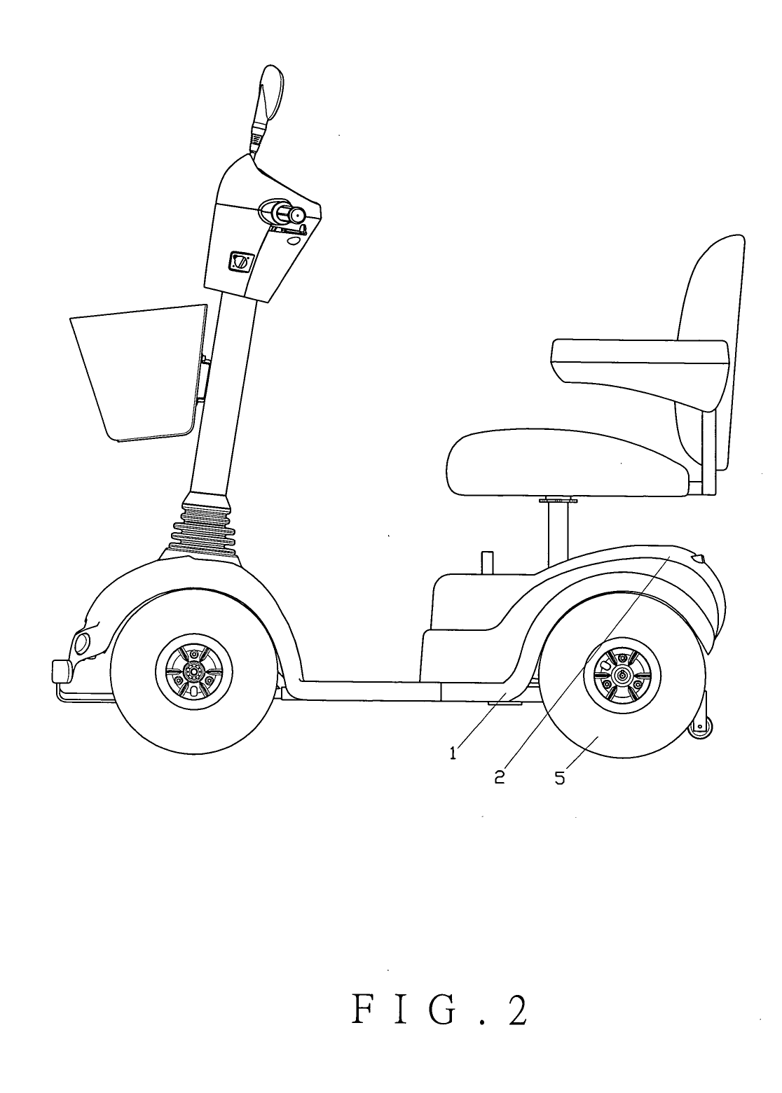

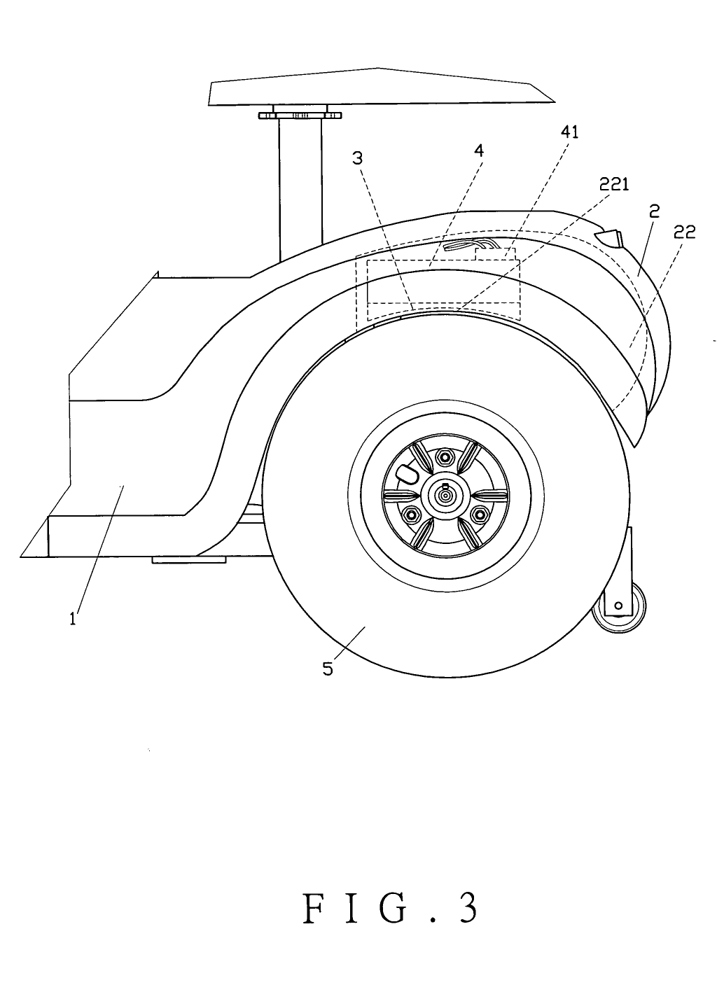

As shown in FIGS. 1-3, the present invention is incorporated with a rear section 1 of an electric mobility scooter, a rear cover 2, a motor 3, and a controller 4. The motor 3 and the controller 4 are secured on the rear section 1. The rear section 1 is pivotally connected with a pair of wheels 5. The rear cover 2 covers the motor 3, the controller 4 and the wheels 5. The controller 4 is secured on the top of the motor 3. Both the motor 3 and the controller 4 are mounted on the rear section 1 with a distance away from the bottom of the electric mobility scooter, so as to avoid water or dust getting onto the controller 4 easily. The controller 4 is provided with wiring terminals 41.

The rear cover 2 has an inner wall 21 to cover the front and rear ends of the controller 4 with a pair of blocking walls 22 extending from the inner wall 21 to enclose the two sides of the controller 4. Each blocking wall 22 has an outer edge 221 corresponding to the contour of the motor 3 so as to engage with the motor 3. The controller 4 and the wiring terminals 41 are enclosed by the rear cover 2 and the blocking walls 22. This design prevents water and dust from getting onto the controller 4.

Because the blocking walls 22 are integral with the rear cover 2, the manufacturing and assembling costs are reduced to increase the competition in the market.

1. A waterproof device for a controller of an electric mobility scooter being incorporated with a rear section of the electric mobility scooter, a rear cover, a motor and a controller, said motor and said controller being secured on said rear section, said rear cover covering said motor and said controller, said rear cover having an inner wall to cover front and rear ends of said controller, and characterized in that:
said rear cover comprising a pair of blocking walls extending from the inner wall to enclose two sides of said controller.

2. The waterproof device for a controller of an electric mobility scooter, as recited in claim 1, wherein each of said blocking walls has an outer edge corresponding to the contour of said motor.
